(19) United States
(12) Patent Application Publication
(10) Pub. No.: US 2006/0219306 A1
(43) Pub. Date: Oct. 5, 2006

(54) Hydraulically switchable directional control valve

(76) Inventor: Michael Dettmers, Kamen (DE)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/553,615

(22) PCT Filed: May 10, 2004
(86) PCT No.: PCT/EP04/04968

§ 371 Date: Oct. 18, 2005

(30) Foreign Application Priority Data
May 13, 2003 (DE) 203 07 512.9

(51) Int. Cl. F15B 13/042

(52) U.S. Cl. 137/625.66

(57) ABSTRACT

The distribution valve 10 comprises a valve piston 12, coupled with this a means of sealing 15; 18 and a control piston 13, where the return port R can be closed off from the control piston 13, and where, after opening of the means of sealing 15; 18 the fluid connection can be made from the high pressure port P to the load port A. With control pressure present the control piston 13 can be displaced from its initial position, via an intermediate position, into an end position, where as a function of the position the fluid connection between the load port A and the return port R can be unrestricted or closed off. The valve piston 12 comprises, displaced towards the end face 26 from a first radial aperture 29, a second radial aperture 28; the first radial aperture 29 can be closed by the control piston 13 when the latter arrives at an intermediate position. Between the valve piston 12 and its guide a restricting section can be formed.

The invention concerns a hydraulic switchable distribution valve, in particular for hydraulic shield supports used in underground mining, with a high pressure port, a load port, a return port, and a control pressure port for hydraulic fluid, a valve piston, in particular of a hollow piston shape, that can be axially displaced in a location hole of a valve seat mounting, which at its open end is connected with the load port, which comprises a radial aperture and which when in contact with a sealing seat on the valve seat mounting side blocks off the load port from the high pressure port; and also with a control piston which can be displaced in a control piston guide by means of force exerted by a control pressure at the control pressure port, by means of which the return port, as a function of the position of the control piston, can be connected with the load port or can be blocked off from the load port and the high pressure port.

In underground mining distribution valves of like kind are used, which are hydraulically actuated via a control pressure and which automatically close in a dead man function if the control pressure falls; these are used in particular for the control of hydraulic walking excavation machines in the deployment or retraction of their hydraulic rams. The walking excavation machines are positioned along a longwall face front and during the progressive excavation operation on the longwall face are moved along with supporting rams retracted, which requires frequent repetition of the switching procedures. Moreover the supporting forces that must be provided on the longwall face require a very high fluid pressure, so that all in all the distribution valves are subject to very high loads generated by alternating pressures and the valve sealing seats are subject to high impact loads.

From DE 197 08 741 A1 a 3/2 distribution valve of like kind is of known art, which even with high pressures and frequently occurring alternating pressure loads demonstrates a high service life and high switching reliability. However, since this valve operates with a positive overlap, pressure peaks of up to 1000 bar can be generated during switching, such that the result is a hard switching process that is undesired. In addition this valve of known art requires a high control pressure of about 230 bar, as a result of which the wear on the control piston face is undesirably high.

From DE 100 47 073 C1 a hydraulically switchable distribution valve is of known art, which in its method of working operates according to the principle of negative overlap. Correspondingly opening and closing of this valve without hard switching processes is ensured, with significantly reduced wear, since during the closing of the return circuit of the valve the inlet circuit is softly opened at the same time, as a result of which impact loads generated by alternating pressures can essentially be avoided. With this distribution valve the inlet circuit of the high pressure port is so designed that when the valve opens the hydraulic fluid flows firstly through a restricting section to the load port, the result of which is a disadvantageous delay in the response characteristics of the distribution valve. The control piston is rigidly connected with the valve piston and only closes the return port completely when the valve is in the open state. In the closed state of the valve, i.e. with the high pressure port closed, the fluid connection between the load port and the return port leading to the tank is fully opened via radial holes in the valve piston.

The object of the invention is to specify a hydraulically switchable distribution valve that is distinguished by a materials-friendly mode of operation and a rapid response characteristic.

In accordance with the invention the task is solved by means of a hydraulic switchable distribution valve with the features of Claim 1. Advantageous further configurations of the invention are defined in the dependent claims. The task as prescribed is solved by the invention in that the valve piston comprises a second radial aperture that is displaced towards the end face relative to the first radial aperture, and in that the first radial aperture can be closed by the control piston with the arrival of the control piston at an intermediate position between an initial position and an end position. Since the distribution valve in accordance with the invention comprises radial apertures that are axially displaced relative to one another, one of which can be closed with the control piston when it is under a load generated by control pressure, that is to say, is closed with the imposition of control pressure, a significantly better response characteristic can be achieved for the distribution valve.

In the preferred configuration the valve piston is guided between both radial apertures in a valve piston sliding guide with the formation of a restriction clearance, where preferably the second radial aperture, as a function of the location of the valve piston, lies opposite to the valve piston sliding guide, or lies on the high pressure side of the valve piston sliding guide. After the control piston has reached its intermediate position and as a function thereof, whether the valve piston is in contact with the sealing seat or has lifted off from the latter, a restricted fluid connection between the load port and the return port or a restricted fluid connection between the high pressure port and the return port is ensured via the restriction clearance only in the open state of the distribution valve, i.e. if the control piston and valve piston are located in the end position, is the fluid connection between the high pressure port and the load port completely unrestricted via the second radial aperture, while at the same time the control piston also closes the return port so that consequently no further leakage occurs from the high pressure port to the return port. With increasing displacement of the valve piston into the open position of the distribution valve the clearance length of the clearance seal increases and with it the sealing effect of the clearance seal.

The location in accordance with the invention of the second radial aperture of the valve piston ensures that in the intermediate position of the control piston, i.e. with the first radial aperture closed, a restriction effect between the load port and the return port is maintained, in that here the hydraulic fluid flows through the second aperture and a small clearance between the surface of the valve piston slide guide facing the control piston and the outer wall of the valve piston. Furthermore a reliable switching characteristic of the distribution valve in its open position is provided with the avoidance of undesired flow losses from the high pressure port back to the return port, in that when the valve piston is fully actuated and the hydraulic fluid at maximum pressure passes from the high pressure port through the second radial aperture to the load port, the return port is closed by the control piston in its end position.

In the distribution valve switching procedure the control piston is therefore firstly driven into the intermediate position while the distribution valve is still in the closed position, i.e. with the sealing seat closed, with the result that a restricted fluid connection is formed between the load port and the return port. What is advantageous here is that the hydraulic fluid from the high pressure port is not introduced, so that in the closed position of the distribution valve it is possible to achieve a softer retraction for any particular ram and with it a materials-friendly mode of operation of the distribution valve. A softer retraction of the ram furthermore has overall an advantageous effect on the service life of the walking excavation machine in question. This function of the distribution valve in accordance with the invention also offers the advantage that, where applicable, it may be possible to do without an additional external throttle valve, which leads to cost savings and keeps the space requirement associated with the distribution valve small. In the intermediate position of the control piston, with the valve cone lifted off, the return port is not yet closed; moreover the fluid connection between the high pressure port and the return port is restricted via the clearance seal. At the same time the flow between the high pressure port and the load port via the valve piston is essentially unrestricted. Hereby it is possible advantageously to avoid undesired pressure peaks during the actuation of the distribution valve, since in this position of the control piston any possible pressure peaks can be weakened or compensated for as a result of the restriction between the high pressure port and the return port. As a result of the essentially unrestricted flow from the high pressure port to the load port with the actuation of the distribution valve, i.e. with the lift-off of the valve cone from the sealing ring, it is furthermore possible to achieve an advantageously rapid response characteristic for the distribution valve, which markedly improves operational safety when used in underground mining.

It is particularly advantageous if the control piston is free to slide relative to the valve piston from its initial position up to its intermediate position.

In this manner the control piston in a simple design configuration can be free to slide axially relative to the valve piston, whereby a displacement of the control piston by means of a hydraulic fluid control pressure imposed on the end face of the control piston can be implemented in a known manner. As an alternative to this option the control piston could also be displaceable relative to the valve piston in a rotational manner, such that with an appropriately imposed control pressure it rotates from its initial position into an intermediate position and thus overlaps or in other words closes the first radial aperture of the valve piston. Here the control piston can in the intermediate position and end position overlap the first radial aperture to form a seal, or overlap the latter to form a restriction clearance.

Advantageously with further actuation of the distribution valve the control piston is traversed, coupled with the valve piston, into its end position. Here the control piston, on its face that is facing the control pressure port, can exhibit an inward-facing flange, that with arrival at the intermediate position comes into contact with a shoulder section of the valve piston, and thus with ongoing actuation of the distribution valve forces a common movement of the control piston and valve piston on the basis of a form fit between them. Expressed in another way, the coupling of the control piston with the valve piston takes place by means of a form fit between the inward-facing flange of the control piston and the shoulder section of the valve piston. As a result of the ability of the control piston to move freely until it is in its intermediate position, in which the first radial aperture is closed by the control piston, it is possible advantageously to achieve, as described above, a restriction between the load port and the return port, without the high pressure port thereby being opened by a lift-off of the valve cone.

The means of sealing to close the sealing seat with a reliable sealing effect between the valve piston and the valve seat mounting can advantageously consist of a valve cone on the valve piston and a sealing ring that is located on the valve seat mounting and comprises a conical face as the sealing seat. With the means of sealing closed the valve cone is in contact with the sealing ring, and with the means of sealing opened the valve cone is lifted off from the sealing ring.

In accordance with a preferred design configuration the sealing ring is fixed in the valve seat mounting by a retaining ring. Furthermore the valve piston can be guided without sealing in the valve seat mounting along the retaining ring between the high pressure port and the return port. The tolerances between valve piston and retaining ring can hereby advantageously be selected such that between these components there is adjusted a small amount of play, or in other words, a small clearance.

From the manufacturing technology point of view it is particularly favourable if the valve piston on its external wall surface comprises a cone face ring, on the underside of which the valve cone is fitted, since this enables the valve piston to be manufactured cost-effectively as a turned or cast component. Advantageously hereby the cone face ring is located on the high pressure side of the two radial apertures., which ensures that with the lift-off of the valve cone from the sealing ring the hydraulic fluid through the thus unrestricted high pressure port immediately gains access to the second radial aperture of the valve piston and flows through this to the load port. At the same time this enables the hydraulic fluid to flow through the restricting section as described above between the retaining ring and the outer wall of the valve piston to avoid pressure impact loads.

The control piston can exhibit a control piston shaft, which in part surrounds the valve piston on its tank-side located lower section, and in the intermediate and end positions of the control piston overlaps and thus closes the first radial aperture. A reliable closure of the return port can advantageously be ensured, if in the end position of the control piston a forward, preferably outer end of the control piston shaft comes into sealing contact with a sealing seat element located in the valve seat mounting. Here a preferably inner contact face of the sealing seat element can be conically formed, adapted to the forward end of the control piston shaft, as a result of which a very reliable sealing effect occurs at this location. An integration of the retaining ring and the sealing seat element, by which these two components are formed into a single unit, allows for a simple design and leads to favourable manufacturing costs.

The valve seat mounting can exhibit a stepped location section, in which the sealing ring and the retaining ring can be clamped in a form fit manner. In this manner it is possible to locate both the ring elements in the manufacture of the distribution valve in a simple manner, and in which moreover they are well protected from external loadings. Here the retaining ring preferably encompasses the sealing ring on the side that its facing away from the piston sealing face with an inward chamfered ring mounting in a form fit manner, whereby the sealing ring is very securely positioned in its location. For high switching reliability the sealing ring can be manufactured out of a preferably high strength plastic. With a valve cone manufactured e.g. from steel, an advantageous reconciliation of tolerances occurs between these elements and this produces at the same time a good sealing performance. As with the valve cone, the retaining ring can also be manufactured preferably out of a steel. In an advantageous design configuration the individual components of the distribution valve cited above are clamped by means of a screw fixing in the valve housing in a force fit manner. Here the screw fixing closes off the location hole of the valve seat mounting toward the outside. In the event of alternating pressure loads occurring the clamping force of the screw fixing avoids any loosening up of the installed parts. The stepped location of the valve seat mounting is here configured such that the clamping force of the clamping screw does not affect the plastic sealing ring which is sensitive to compressive forces.

Excessive loading or even damage to the sealing ring can in this manner be avoided, whereby the operational reliability and service life of the distribution valve is increased. A reliable closed position of the distribution valve, in which the valve cone is located in sealing contact with the sealing ring, can be achieved preferably by a closing spring located in the valve seat mounting, that interacts with the valve piston, e.g. the with an upper face of the cone face ring and thereby clamps the valve cone against the sealing ring in the dead man function. Also the control piston could be clamped by any clamping device in its initial position; however, a return movement of the control piston from its intermediate position into its initial position is preferably performed while under control by pressure.

The first radial aperture and/or the second radial aperture can lead as radial holes into the axial hole in the valve piston shaped as a hollow piston,.and/or the radial apertures can include a number of radial holes, preferably four, located around the circumference and spaced apart from each other. Radial holes can be manufactured in a simple and cost-effective manner, where with a number of radial holes for each aperture large flow cross sections can be achieved. Other configurations of the valve piston are, however, also possible, which ensure a radial aperture in its outer wall to its interior space.

The valve piston is preferably axially secured in the valve seat mounting with a sprung ring and fitted with a connecting thread or similar for a disassembly tool. The distribution valve can then be extracted out of the valve housing as a valve cartridge in a module, such that the disassembly tool is screwed on to the valve piston, or is secured in another suitable manner, and the cartridge is then pulled out with the disassembly tool on the valve piston. Here the sprung ring located on the valve piston is in contact with the valve seat mounting, and furthermore the shoulder section of the valve piston is in contact with the inward-facing flange of the control piston, whereby the essential components of the distribution valve can be jointly pulled out of the valve housing in the form of a valve cartridge.

The invention and advantageous details are described in more detail in the following paragraphs with reference to the drawings of an example of a design configuration. In the figures:

FIG. 1 shows a longitudinal section of the closed position of the distribution valve in accordance with the invention,

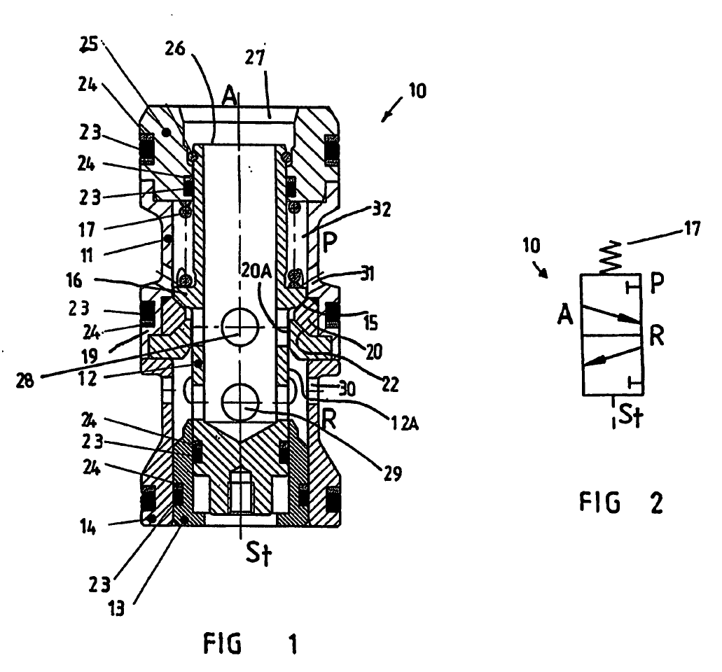

FIG. 2 shows a circuit schematic for the distribution valve in accordance with the invention in the position of FIG. 1;

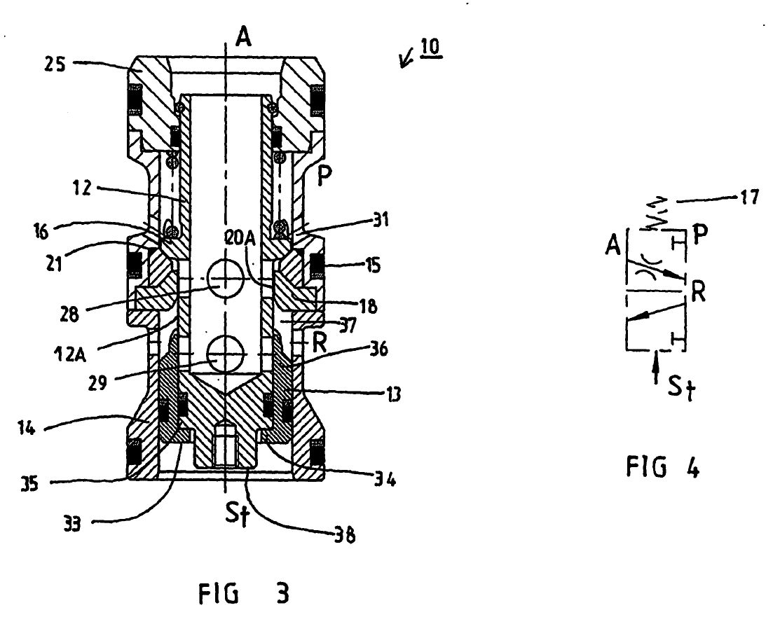

FIG. 3 shows a longitudinal section of the distribution valve in accordance with the invention located in an intermediate position;

FIG. 4 shows a hydraulic circuit schematic of the distribution valve in accordance with the invention in the position of FIG. 3;

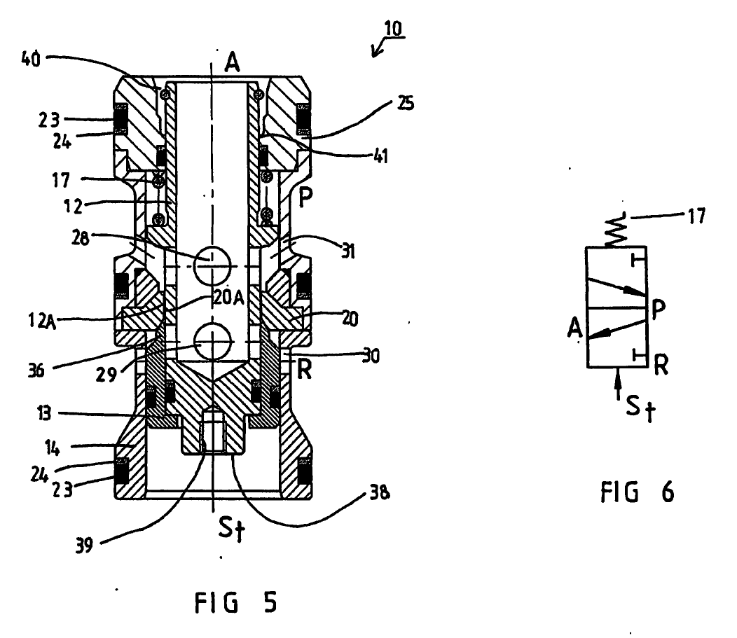

FIG. 5 shows a longitudinal section of the opening position of the distribution valve in accordance with the invention; and

FIG. 6 shows a circuit schematic of the distribution valve in accordance with the invention in the position of FIG. 5.

FIG. 1 shows a distribution valve 10 in the closed position. A hydraulically switchable distribution valve serves e.g. for the control of the hydraulic rams (not represented) of hydraulic walking excavation machines in underground mining, e.g. during excavation on a longwall face. The valve is configured as a valve cartridge that is inserted into a location hole of a valve housing (not represented) and is secured therein by means of a screw fixing. The valve housing with its location hole, the corresponding aperture openings that adjoin the respective ports of the distribution valve, and the screw fixing can be designed in the manner known to the specialist, as published e.g. in D3 197 08 741 A1, to which reference is made for further explanation in this regard. In the valve housing (not shown) are fitted a high pressure port P for the high pressure fluid inlet circuit, and a load port A, which is connected with the hydraulic ram that is to be actuated. Furthermore the valve housing comprises a return port R for hydraulic fluid that is flowing in the return circuit, as well as a control pressure port ST, via which control pressure fluid is fed to the valve for its actuation.

The distribution valve 10 consists essentially of a valve seat mounting 11 with a valve piston 12 that can slide axially therein in a guided manner, and a control piston 13, which is supported in a control piston guide 14 in which it can slide axially. Both the valve piston 12 and also the control piston 13 are preferably designed as hollow cylinders.

The control piston 13 is here so configured that it surrounds part of a tank-side located section of the valve piston 12 in the form of a cup.

The valve piston 12 is fitted with a valve cone 15, which is provided on a bottom surface of a cone surface ring 16 located on the external wall face of the valve piston 12. In the valve seat mounting 11 a closing spring 17 is located that surrounds the valve piston 12. In the closed position of the distribution valve 10 represented here, the closing spring 17 presses against an upper face of the cone surface ring 16 and thus brings the valve cone 15 into sealing contact with a conical surface of a sealing ring 18. The valve seat mounting 11 comprises a stepped location section 19, in which the sealing ring 18 together with a retaining ring 20 are clamped in a form fit manner. To achieve an excellent sealing effect with appropriate tolerances the sealing ring 18 is preferably made of a high strength plastic, while the retaining ring 20 is preferably manufactured out of a steel.

As can be easily discerned from FIG. 1 as well, the retention ring 20 surrounds the sealing ring 18 on the side that its facing away from the piston sealing face of the sealing ring 18 with an inward chamfered ring mounting 22 in a form fit manner, such that the sealing ring 18 is positioned very reliably in the valve seat mounting 11. Moreover the location section 19 of the valve seat mounting 11 in conjunction with the steel retaining ring 20 is so configured that a clamping force exerted by the screw fixing (not shown) via the control piston guide 14 does not act on the plastic sealing ring 18.

The end of the valve piston 12 facing away from the valve cone 15, in FIG. 1 the upper end, is sealed by means of a shaft seal consisting of an O-ring 23 and a support ring 24 against a guide ring 25 that is fitted on to the front face of the valve seat mounting 11 facing the load port A, and surrounds-an open end face 26 of the valve piston 12. Corresponding to the load port A an opening 27 is formed in the guide ring 25. The upper end of the closing spring 17 is supported on an bottom surface of the guide ring 25, so that it correspondingly exerts pressure on the cone surface ring 16 and holds the valve cone 15 in position against the sealing ring 18.

The hollow cylindrical valve piston 12 comprises a first radial aperture 29 and a second radial aperture 28, that preferably are configured in each case as radial holes or as radial cut-outs in the valve piston wall. Here the second radial hole is so configured in the valve piston 12, that in the closed position of the distribution valve it lies opposite to a valve piston guide 20A configured on the inner wall surface of the retention ring; it therefore lies with the whole of its hole cross-section at the same height as the retention ring 20, and is blocked by the latter as far as possible. With an actuation of the distribution valve and a corresponding displacement of the valve piston 12 (upward in FIG. 1) the second radial hole 28 remains located on the high pressure side. As can be clearly discerned from FIG. 1, the valve piston 12 is thus guided without seals in the valve seat mounting 11 along a surface of the retention ring 20 facing the valve piston 12 between the high pressure port P and the return port R, i.e. without sealing rings or similar. Moreover, the separation or tolerance between the outer wall of the valve piston 12 and the valve piston guide surface 20A of the retaining ring 20 facing the valve piston 12 is chosen such that it forms at this location a narrow clearance as a clearance seal, through which the hydraulic fluid can flow in a restricted manner. Both in the closed position of the the distribution valve shown in FIG. 1 and also during the later displacement of the valve piston 12 this clearance remains as a restricting section, however the overlap of the outer wall section 12A between the two radial apertures 28, 29 and the valve piston guide face 20A increases with displacement of the valve piston 12, as in particular the end position of the valve piston 12 in FIG. 5 shows, so that because of the greater length of the clearance the sealing effect of the clearance seal also increases. In what follows this clearance between the outer wall 12A of the valve piston 12 and the surface 20A on the retaining ring 20 is identified in brief as a restricting section. The first radial hole 29 of the valve piston 12 is configured on the tank side of the second radial hole 28, such that it is located in alignment with the return port R. The control piston guide 14 comprises aperture openings 30, which correspond with the return port R. In like manner the valve seat mounting 11 comprises aperture openings 31, which correspond with the high pressure port P.

In the closed position of the distribution valve 10 represented in FIG. 1 the load port A is connected with the return port R essentially via the open first radial hole 29 of the valve piston 12 configured as a hollow piston, so that hydraulic fluid can flow back from the ram via this connection into the tank without loss. At the same time the high pressure port P is connected via the aperture opening 31 with an interior space 32 of the valve seat mounting 11, such that the interior space 32 is filled with hydraulic fluid flowing in from the high pressure port P, and the pressure in the high pressure port impacts upon the valve piston 12. In addition to the clamping force applied by the closing spring 17 already cited, this additionally acts to press the valve cone 15 against the sealing ring 18, so that the valve piston 12 is held very securely in its closed position, and correspondingly no high pressure fluid from the high pressure port P can flow to the load port A or to the return port R. The hydraulic closed position of the distribution valve 10 is represented in FIG. 2 in a corresponding circuit schematic. The design configuration of the distribution valve, as described above, features a 3/2 distribution valve, where in the closed position, as described, a fluid connection exists between the load port A and the return port R. Here the closing spring 17 referred to above is correspondingly identified by a symbol, which clamps the valve piston 12, respectively the valve cone 15, against the sealing ring 18.

FIG. 3 shows the distribution valve 10 in an intermediate state, in which the control piston 13 has moved from its initial position into an intermediate position. For this purpose a hydraulic fluid fed from the control pressure port ST exerts the control pressure, and hence an opening force, on the annular end face 33 of the control piston. As the control piston 13 is axially displaced from its initial position it is guided within the control piston guide 14; the control piston 13 with control pressure exerted is pushed in the direction of the valve piston 12 (upward in FIG. 3), until an inward-facing flange 34, which is formed together with the annular end face 33, comes into contact with a shoulder section 35 of the valve piston 12, the shoulder section being formed in a lower region of the tank-side located section of the valve piston 12. If the inward-facing flange 34 of the control piston 13 is located on the shoulder section 35 of the valve piston, the intermediate position of the control piston is thereby defined. Here the hydraulic fluid acts also on a bottom-side end face 38 of the valve piston 12, however the level of the control pressure at the start of the switching movement of the distribution valve 10 leads in conjunction with the corresponding area ratios to an upward directed force, which is smaller than the closing forces that are generated by the closing spring 17 and the pressure-side high pressure fluid on the valve piston 12.

As a result the control pressure selected here for displacement of the control piston (still) does not produce any displacement of the valve piston 12.

The control piston 13 comprises in its forward part, facing the valve piston 12, a control piston shaft 36, which with the displacement of the control piston 13 into its intermediate position overlaps the first radial hole 29 and thereby closes it. The tolerances between the forward end of the control piston shaft 36 and the part of the valve piston adjoining the second radial hole 28 are appropriately selected with regard to a sufficient sealing effect. As a result the fluid connection between the load port A and the return port R through the first radial hole 29 is interrupted, so that the hydraulic fluid flowing back from the ram can no longer gain easy access back to the tank through the first radial hole 29; at most it can gain access via a restricting section between the first radial aperture 29 and the control piston 13. The control piston 13 can also seal off the first aperture 28 completely. The hydraulic fluid is then forced to move through the second radial hole 28 that is still open and lying axially displaced in the direction of the open end face 26 of the valve piston 12, and subsequently through the single or further restricting section there formed. As can be further discerned from FIG. 3, an annular clearance 37 is formed within the control piston guide 14 in the intermediate position of the control piston 13 above the control piston shaft 36. The hydraulic fluid flowing back from the ram, which has passed through the second radial hole 28 and through the restricting section can furthermore flow back via the annular clearance 37 and through the flow opening 30 to the tank, i.e. to the return port R. Thus is ensured a soft forward or return travel of the ram with the advantages cited above.

The control pressure from the control pressure port ST applied on to the control piston 13 is selected such that in the first instance only the control piston 13 is moved from its initial position into its intermediate position, without the valve piston 12 also being actuated at the same time. In the first instance therefore the valve piston 12 remains in its closed position in which the valve cone 15 is in contact with the sealing ring 18 and blocks the flow of hydraulic fluid from the high pressure port P to the second radial hole 28. By the separate displacement of the control piston 13 from its initial position into its intermediate position the flow from the load port A to the return port R can therefore be restricted without hydraulic fluid from the high pressure side P thereby being included with it. In this manner it is possible to implement a soft return or forward travel of the ram by means of the distribution valve alone, without having to include additional external throttling valves. FIG. 4 shows a hydraulic circuit schematic for the intermediate position of the distribution valve 10 in accordance with FIG. 3.

The restriction effect between the load port A and the return port R that has been described is symbolically indicated.

The switchover of the valve and the traversing of the valve piston 12 from the closed state into the open state takes place with maximum control pressure, after the control piston 13 has been traversed into its intermediate position and is already in contact with the valve piston. The hydraulic fluid fed from the control pressure port ST impacts at the same time the annular end face 33 of the control piston 13 and on the bottom-side end face 38 of the valve piston 12, the resulting total area being larger than the annular end face 33 of the control piston that is impacted upon at the beginning of the switching movement by the control pressure. The force exerted via the control pressure on the total area 33, 38 is now high enough to overcome the clamping force acting in an opposing direction on the valve piston 12. As a result of the form fit between the inward-facing flange 34 and the shoulder section 35 the control piston 13 together with the valve piston 12 moves further upward in the drawing. With this displacement of the valve piston 12 the valve cone 15 lifts off from the sealing ring 18, so that hydraulic fluid can flow from the high pressure port P via the flow opening 31 through the second radial hole 28 and the hollow cylindrical valve piston 12 to the load port A. The control piston shaft 36 closes now, as before, the first radial hole 29 and thus prevents any flow of the hydraulic fluid through the first radial hole 29 back to the tank.

After the lift-off of the valve cone 15 from the sealing ring 18 a large clearance forms immediately between these two components so that the aperture between the high pressure port P and the second radial hole 28 is essentially unrestricted and a large quantity of hydraulic fluid can flow through. In this way the distribution valve comprises a rapid response characteristic when actuated. Since with the lift-off of the valve cone 15, or the cone face ring 16, from the sealing ring 18 hydraulic fluid can access the bottomsurface of the cone face ring 16, an equalisation of pressure occurs with the result that further actuation of the valve piston 12 takes place in a prompt and rapid manner as required. At the same time it is possible with the lift-off of the valve cone 15 to avoid disadvantageous pressure shocks, since the inflowing hydraulic fluid can similarly gain access downward to the restricting section and can furthermore gain access back to the tank through the annular clearance 37, not yet closed, and the aperture opening 30. The plastic sealing ring 18 is sealed with respect to the valve seat mounting 11 by means of an O-ring 21 inserted between the latter and the sealing ring 18; this effectively prevents pressure from the high pressure fluid fed from the high pressure port P from building up behind the plastic sealing ring 18.

From the drawing it can be seen that the control piston 13 comprises a diameter that corresponds to the diameter of the valve seat mounting 11. Similarly the diameters of the control piston shaft 36 and the effective opening diameter of the valve cone 15 are also at least approximately equal. Through this co-ordination of the respective diameters a pressure equalisation is achieved, such that only a comparatively small control pressure is necessary for opening of the distribution valve 10, since this must essentially only overcome the closing force of the closing spring 17. In this way very reliable switching behaviour is achieved for the distribution valve 10.

FIG. 5 shows the distribution valve 10 in its open position. The location of the second opening 28 and its distance from the first opening 29 is selected such that the connection between the aperture opening 31 and the second radial hole 28 is now completely unrestricted and thus no flow losses occur between the high pressure port P and the load port A. As can be further discerned from FIG. 5, the control piston 13 achieves its end position when the distribution valve 10 is in the open position. Here a forward end of the control piston shaft 36 comes into sealing contact with a matched conically formed region of the retention ring, such that the annular clearance 37 to the restricting section is closed and thus the return port R is closed. The retention ring 20 thus serves at the same time as a sealing seat element for the forward end of the control piston shaft. By means of the conically formed region of the retention ring 20 as cited it is possible to achieve an excellent sealing effect between the retention ring and the control piston shaft. The return port R is moreover closed by the control piston 13, in that an external wall of the control piston shaft 36 overlaps the aperture opening 30 corresponding with the return port R. The tolerances between the material pairs are hereby chosen appropriately so as to achieve the desired sealing effect. Because of the closed return port R disadvantageous leakage flows cannot occur with a fully actuated distribution valve from the hydraulic fluid flowing in from the high pressure port P through the restricting section; the length of the clearance between the surfaces 12A, 20A that are in contact with each other already minimises any such leakage. As a result the hydraulic fluid can here flow without loss from the high pressure port P to the load port A. The open position of the distribution valve 10 is represented in FIG. 6 in a corresponding circuit schematic.

To guarantee the necessary sealing effect between the components of the distribution valve that are moved relative to each other a number of shaft seals are provided, in each case consisting of an O-ring 23 and a support ring 24. In addition to the sealing location, already described above, between the guide ring 25 and the valve piston 12, these shaft seals are further provided between an internal wall of the control piston shaft 36 and the valve piston 12, between an external wall of the control piston shaft 36 and an inner wall of the control piston guide 14 and also between respective external walls of the guide ring 25, the valve seat mounting 11 and the control piston guide 14 and the location hole of the valve housing (not shown).

The distribution valve in accordance with the invention can be extracted out of the valve housing as a valve cartridge, in a module containing all its essential components. For this purpose the valve piston 12 comprises on its bottom-side end face 38 a connecting thread 39. A disassembly tool (not shown) can be screwed in for extraction of the valve cartridge. Furthermore at the upper end of the valve piston 12 a sprung ring 40 is located, that makes contact with a shoulder 41 of the guide ring 25 when the valve piston 12 is pulled downward (downward in FIG. 5). In this way it is possible for the valve cartridge as a whole to be pulled out of the location hole of the valve housing by means of the screwed-in disassembly tool.

The invention is not limited to the configuration form as presented and described; rather there are a large number of modifications and expansions that are possible, without moving beyond the scope of the invention. A “seal-free guide” between the valve piston and the retention ring can also be understood in the general sense such that a restricted overflow of hydraulic fluid from the interior space 32 into the annular clearance 37 is thereby possible with the cone face ring 16 lifted off. As alternatives to the configuration described above suitable overflow passages or holes can also be provided, where the restriction effect as required is generated with a return port R that is not closed. A further or an alternative restricting section can also be provided between the front end of the control piston shaft and the first radial aperture, such that this is consequently only approximately completely covered or sealed in the intermediate position of the control piston. Moreover the distribution valve in accordance with the invention can also be used for other hydraulic switching tasks.

1. Hydraulical switchable distribution valve in particular for shield supports in underground mining, with:
a high pressure port, a load port, a return port, and a control pressure port for hydraulic fluid;
a valve piston, axially displaceable in a location hole of a valve seat mounting, which at its open end face is connected to the load port, which comprises a radial aperture and which when in contact with a sealing seat on the valve seat mounting side blocks off the load port from the high pressure port;
a control piston in a control piston guide, which can be displaced by means of a force exerted by a control pressure at the control pressure port, by means of which the return port, as a function of the position of the control piston, can be connected with the load port or can be blocked off from the load port and the high pressure port, wherein
the valve piston comprises a second radial aperture, displaced towards the end face relative to the first radial aperture, and that the first radial aperture can be closed by the control piston with the arrival of the control piston at an intermediate position between an initial position and an end position.

2. Distribution valve in accordance with claim 1, wherein the valve piston is guided between both radial apertures in a valve piston sliding guide with the formation of a throttling clearance.

3. Distribution valve in accordance with claim 1, wherein the second radial aperture, as a function of the location of the valve piston, lies opposite to the valve piston sliding guide or lies on the high pressure side of the valve piston sliding guide.

4. Distribution valve in accordance with claim 1, wherein the throttling clearance, if the control piston is positioned in the intermediate position, with contact between the valve piston with the sealing seat, forms a restricted fluid connection between the load port and the return port, and with an opened sealing seat forms a restricted fluid connection between the high pressure port and the return port.

5. Distribution valve in accordance with claim 1, wherein the load port in the initial position of the control piston is connected with the return port via the first radial aperture, and in that the control piston in its end position closes off the return port, where the second radial aperture completely unblocks the fluid connection between the high pressure port and the load port.

6. Distribution valve in accordance with claim 1, wherein the control piston is free to move relative to the valve piston from its initial position up to its intermediate position, and travels from the intermediate position to the end position coupled with the valve piston.

7. Distribution valve in accordance with claim 6, wherein the control piston at its end face facing the control pressure port comprises an inward-facing flange, which in the intermediate position of the control piston comes into contact with a shoulder section of the valve-piston.

8. Distribution valve in accordance with claim 8, wherein the valve piston is fitted with a valve cone and that a sealing ring with a cone surface provided for the sealing seat is located on the valve seat mounting.

9. Distribution valve in accordance with claim 8, wherein the sealing ring is fixed in the valve seat mounting by means of a retention ring and wherein the retention ring with its interior wall surface forms the valve piston sliding guide.

10. Distribution valve in accordance with claim 8, wherein the valve piston on its outer wall surface comprises a cone face ring, on the bottom surface of which is provided the valve cone, the cone face ring being located on the high pressure side of the second radial aperture.

11. Distribution valve in accordance with claim 1, wherein the valve piston on its outer wall surface comprises a cone face ring, on the bottom surface of which is provided the valve cone, the cone face ring being located on the high pressure side of the second radial aperture.

12. Distribution valve in accordance with claim 9, wherein the control piston comprises a control piston shaft, that in the intermediate and end positions of the control piston overlaps the first radial aperture so as to sealedly overlap it or overlap the latter while leaving a throttle clearance.

13. Distribution valve in accordance with claim 12, wherein a sealing seat element is located in the valve seat mounting on which, in the end position of the control piston, a forward end of the control piston shaft comes into sealing contact.

14. Distribution valve in accordance with claim 13, wherein the retention ring and the sealing seat element are formed in one piece and/or that the valve seat mounting comprises a stepped location section in which the sealing ring and the retention ring are clamped in a form fit manner.

15. Distribution valve in accordance with claim 12, wherein the retention ring surrounds the sealing ring on the side facing away from the piston sealing face with an inward chamfered ring mounting in a form fit manner.

16. Distribution valve in accordance with claim 2 to 15, wherein the sealing ring is manufactured from a plastic and the retention ring is manufactured from a steel.

17. Distribution valve in accordance with claim 1, wherein the individual components of the distribution valve are clamped in a force fit manner by means of a screw fixing in the valve housing, which screw fixing closes off the location hole toward the outside.

18. Distribution valve in accordance with claim 9, wherein a closing spring located in the valve seat mounting acts together with the valve piston such that the valve cone is clamped against the sealing ring.

19. Distribution valve in accordance with claim 1, wherein the first radial aperture and the second radial aperture are configured as a radial hole and the radial apertures consist of a number of radial holes, preferably four, located around the circumference and spaced apart from each other.

20. Distribution valve in accordance with claim 1, wherein the valve piston is axially secured in the valve seat mounting with a snap ring.

21. Distribution valve in accordance with claim 1, wherein the valve piston comprises on its closed face opposite to the open end face a connecting thread for connection of a disassembly tool.
